(19) United States
(12) Patent Application Publication
(10) Pub. No.: US 2008/0059278 A1
(43) Pub. Date: Mar. 6, 2008

(54) OFFERING UPTIME ADJUSTMENTS TO A WORK SCHEDULE

(75) Inventors: Steven J Medina, Omaha, NE (US); Joseph S. Cox, Omaha, NE (US); Kenneth A. Marr, Ashland, NE (US)

Correspondence Address: MICHELLE A. ZARINELLI;C/O WEST CORPORATION, 11808 MIRACLE HILLS DR., MAIL STOP: W11-LEGAL, OMAHA, NE, 68154, US

(73) Assignee: West Corporation, Omaha, NE (US)

(21) Appl. No.: 11/565,677

(22) Filed: Dec. 1, 2006

Related U.S. Application Data
(63) Continuation-in-part of application No. 10/812,857, filed on Mar. 29, 2004.
Application No. 10/812,857 is a continuation-in-part of application No. 09/437,833, filed on Nov. 9, 1999, now abandoned.

(51) Int. Cl. G06F 9/46

(52) U.S. Cl. 705/9

(57) ABSTRACT

A system, method, and computer readable medium for offering uptime adjustments to a work schedule for at least one currently unscheduled agent possessing at least one skill type, that comprises, accepting at least one forecasted manpower requirement of zero or more agents for an interval of time for a skill, requesting an uptime display for an unscheduled time period of the at least one currently unscheduled agent, assessing the type and number of skill types of the at least one currently unscheduled agent, determining a manpower availability for the an interval of time based upon all agents currently scheduled for each skill type based upon the forecasted manpower requirement, calculating a manpower delta between the forecasted manpower requirement for the an interval of time and the determined manpower availability for each skill type, and offering an uptime adjustment if the calculated manpower delta shows additional manpower is required for any skill possessed by the at least one currently unscheduled agent.

### CROSS REFERENCE TO RELATED APPLICATIONS

This application is a continuation-in-part of pending U.S. application Ser. No. 10/812,857, filed on 29 Mar. 2004, which in turn is a continuation-in-part of U.S. patent application Ser. No. 09/437,833, filed on 9 Nov. 1999, now abandoned, the contents of which are incorporated herein by this reference. The applicants claim the benefit of the filing dates of the above applications to the fullest extent permitted by 35 U.S.C. § 120.

The present patent application is also related to commonly assigned U.S. patent application Docket No. PAT-005C entitled MAINTAINING A WORK SCHEDULE, U.S. patent application Docket No. PAT-005D entitled DYNAMICALLY ALLOCATING A WORK SCHEDULE, U.S. patent application Docket No. PAT-005F entitled PROPOSING DOWNTIME ADJUSTMENTS TO A WORK SCHEDULE and U.S. patent application Docket No. PAT-005G entitled EVENT BASED FORECASTING A WORK SCHEDULE, filed on even date herewith, the entire contents of which are incorporated by reference herein.

### BACKGROUND OF THE INVENTION

The present invention relates generally to employee management tools and in particular to a system configured to manage the work schedules of a plurality of employees.

Historically, management and scheduling of a large employee workforce has been a complex and time consuming task. With regard to scheduling large groups of employees, it is difficult to predict the number of employees required to adequately staff a particular shift. Once the number of required employees is determined, employees must each be assigned a work schedule. Scheduling employees can be a complex task as many different factors constrain which employees may be selected for a particular shift. For example, scheduling limitations exist regarding hours worked per week, hours worked per day, or other factors. Further, some employees are available to work only certain days and/or certain hours. In addition, employees may wish to take vacation time, or to schedule changes for other reasons. Further, certain shifts may unexpectedly require additional employees to meet unexpected increases in workload, or conversely, certain shifts may require fewer employees than previously anticipated.

Workforce Management (WFM) systems have been developed to assist businesses with the challenges of workforce scheduling, particularly in environments where the staffing requirements are variable. Call centers are an excellent example of such an environment. Being correctly staffed is essential to efficient operation of a call center, since too many employees will result in excess labor costs, and two few will results in lost opportunity and/or poor customer service.

The current state of the art for WFM Systems consists of two steps, forecasting how many people will be required for each period of time, and then generating the schedules of the workforce to best meet the forecasted requirements. This results in new schedules for the employees with each new forecast. In order to make the scheduling process friendlier to the employees many systems will allow the manual entry of employee preferences and limitations.

A major deficiency in the current state of the art for WFM systems is that the forecasting/scheduling tasks must be accomplished in enough time to notify the workforce of the required schedules. If the employees schedule will not be fixed, but will be determined by the scheduling system for each period scheduled, you must, as a practical matter, inform people of the schedules they will be expected to work far enough in advance so that they will be available to work their scheduled shifts. This necessitates considerable lead time in the creation of a forecast. Often the schedule is created before all information that would be useful for forecasting is available. Also, any significant change to the forecasting criteria which results in changes to the forecast forces upon management the difficult choice of regenerating schedules for the employees or just trying to adjust the workforce outside of the WFM system.

Another major deficiency with the current state of the art for WFM Systems is that there is often resistance on the part of the employees to work shifts that are (from the employees perspective) arbitrarily assigned by the WFM System. Features like employee preferences, shift bids, and the ability to lock down some of the schedules are attempts to mitigate this problem; however they are not adequate solutions to the problem because loaded information is static and lives are dynamic. The system cannot forecast peoples' actual preferences because they change from day to day.

State of the Art Automatic Call Distribution (ACD) systems are quite sophisticated in how they allow calls to be routed to a population of call center agents. One of the challenges in routing calls to individuals is how to achieve economies of scale when call volumes are low. An effective way to address this problem is to employ multi-skilled agents. A pool of agents who are known to the ACD as being able to handle multiple call type skills, can greatly increase the efficiency of all the agents working the skills. Multi-Skilled (MS) Agents have beneficial impact to the efficiency of agents in a call center that is disproportionate to their numbers in the population.

While the benefits provided by the employment of MS Agents are well established, and the ACD systems provide excellent support for their use, the current state of the art of WFM systems is not up to the task of dealing with the challenges presented by the MS Agent. Most systems make no attempt to deal with MS Agents beyond simply noting that a person scheduled to skill A will also be working skill B.

The real challenge presented by the MS Agents is that the number of agents required is driven by the total number of calls that will be received and must therefore be determined independently for each skill. However the number of agents scheduled is determined by the particular combination of skills that each agent is working. One agent working three skills is not the equivalent of three agents each working one skill. This makes determining how many agents are scheduled to work any given skill difficult to determine when you have MS Agents. Most WFM systems determine all agents as single skilled for scheduling purposes.

Several attempts have been made to overcome these types of problems however, these attempts do not fully overcome the disadvantages of the prior art. For example, U.S. Pat. No. 5,499,291, issued to Kepley, describes a scheduling system that communicates an agents schedule directly to the agent at the agents terminal, thereby preventing the need for manual distribution. The schedule is presented to the agents via video displays that are at each agents actual work station, and thus are available for viewing by a particular agent only when that agent is seated at his or her workstation. Furthermore, the Kepley reference does not provide means to account for schedule changes. Absent these features, a system based on the teachings of Kepley still suffers from many of the disadvantages of the prior art.

Likewise, U.S. Pat. No. 5,289,368, issued to Jordan et al, and U.S. Pat. No. 5,325,292, issued to Crockett, both of which share a common specification, describe systems and methods used to help schedule employee work shifts. However, the methods and apparatus of these systems still possess several disadvantages of the prior art. Among others, system configured according to the teachings of these references still lack an ability to schedule based on employee and not shift, lack an ability to provide the schedules on an employee distributed basis and lack the ability to conveniently and easily deal with schedule changes.

Therefore, what is needed is a new method and apparatus for offering uptime adjustments to a work schedule. More specifically, what is needed is offering uptime adjustments to a work schedule which requests an uptime display, assesses skills, determines manpower availability, calculates manpower delta and offers uptime adjustments.

### SUMMARY OF THE INVENTION

In accordance with the purpose of the invention as broadly described herein there is provided an employee scheduling system for use in a work environment wherein the employee scheduling system facilitates the storage, distribution, and modification of employee schedules.

The present invention WFM system (called Spectrum) departs from traditional WFM Systems because it does not dictate schedules to employees, it offers options for uptime and downtime in accordance with the employers forecasted needs. The present invention provides each employee a fixed weekly schedule, called the recurring schedule, and additionally provides uptime and downtime adjustment offers based on the employee skill set and the forecasted skills needed. Thus the employee has a set schedule and which he has the option to modify in a fashion which optimally meets forecasted man power requirements. If the WFM system forecasts a manpower overage for his skill, then the employee will be offered downtime adjustments, if the WFM system forecasts manpower shortfalls, the employee will be offered uptime adjustments. In this way, the needs of the company for optimal manpower efficiency and the needs of the employee for flexibility are both simultaneously addressed.

The dual schedule concept is unique to the present invention. The current state of the art for WFM systems do not utilize a recurring schedule due to the fact that new schedules are created for the employee each time a forecast is created.

In one embodiment, a scheduling computer executes the scheduling software to achieve the functions of the present invention. The computer and software running thereon receive input from management including but not limited to employee files, workload data, and schedule changes. Also included in various embodiments of the scheduling system are one or more display monitors located remotely from the scheduling computer, one or more work stations or kiosks located remote from the scheduling computer and a remote access module configured to facilitate access to the scheduling data via telephone or computer network.

With regard to embodiments configured with a remote access interface or portal, the scheduling computer communicates with the remote access interface to facilitate the exchange of data over a telephone or a computer network, such as the Internet. This feature advantageously allows a remotely located employee to utilize the features of the scheduling system. In another embodiment, the remote access module is configured to facilitate a connection between one or more remote offices.

In various embodiments, the system may include the ability for management to transmit a request to the employees over one or more access points, such as kiosks or display monitors, requesting additional employees on a particular shift. This is referred to therein as the posting of a sheet by management. In response, the employees may optionally respond to the request at certain access points capable of receiving input, such as a kiosk.

In one embodiment of the present invention, A method for offering uptime adjustments to a work schedule for at least one currently unscheduled agent possessing at least one skill type, that comprises, accepting at least one forecasted manpower requirement of zero or more agents for an interval of time for a skill, requesting an uptime display for an unscheduled time period of the at least one currently unscheduled agent, assessing the type and number of skill types of the at least one currently unscheduled agent, determining a manpower availability for the an interval of time based upon all agents currently scheduled for each skill type based upon the forecasted manpower requirement, calculating a manpower delta between the forecasted manpower requirement for the an interval of time and the determined manpower availability for each skill type, and offering an uptime adjustment if the calculated manpower delta shows additional manpower is required for any skill possessed by the at least one currently unscheduled agent. The method may additionally comprise tabulating uptime adjustment offerings, accepting the offered uptime adjustment by the at least one currently unscheduled agent, modifying the work schedule of the at least one currently unscheduled agent based upon the accepted uptime adjustment, displaying modified work schedule and listing the offered uptime adjustments based upon the calculated manpower delta. The method may further comprise uncoupling each skill type of the at least one currently unscheduled agent, determining whether an uptime adjustment has been requested by the at least one currently unscheduled agent and selecting an uptime adjustment by the at least one currently unscheduled agent. Wherein the interval of time is one scheduled work shift, the assessment has a priority which is based upon the calculated manpower delta and the forecasted manpower requirement is periodically updated.

In a further embodiment of the present invention, a computer readable medium that comprises instructions that comprises, requesting an uptime display for an unscheduled time period for at least one currently unscheduled agent, assessing the type and number of skills of the at least one currently unscheduled agent, determining a manpower availability based upon assessed skills for each skill type, calculating a manpower delta between a forecasted manpower requirement and the determined manpower availability based upon assessed skills for each skill type, offering an uptime adjustment if the calculated manpower delta shows additional manpower is required for any skill assessed to the at least one currently unscheduled agent, and tabulating uptime adjustment offerings. The computer readable medium may additionally comprise instructions for accepting the uptime adjustment by the at least one currently unscheduled agent, modifying a work schedule based upon the accepted uptime adjustment, adding accepted uptime adjustment to a dynamic allocation queue and displaying modified work schedule.

In yet a further embodiment, system for offering uptime adjustments to a work schedule wherein a manpower requirement is forecasted for at least one currently unscheduled agent possessing at least one skill type, that comprises, a memory that receives at least one of, a manpower forecast and a skill assessment for an currently unscheduled agent, and a processor communicably coupled to the memory, wherein the processor, requests an uptime display for an unscheduled time period for at least one currently unscheduled agent, assesses the type and number of skills of the at least one currently unscheduled agent, determines a manpower availability based upon assessed skills for each skill type, calculates a manpower delta between the forecasted manpower requirement and the determined manpower availability based upon assessed skills for each skill type, and offers an uptime adjustment if the calculated manpower delta shows additional manpower is required based upon assessed skills. The system processor may additionally accept the uptime adjustment by the currently unscheduled agent and modify the work schedule based upon the accepted uptime adjustment.

### BRIEF DESCRIPTION OF THE DRAWINGS

FIG. 1 depicts a block diagram of an example environment of the present invention in accordance with a preferred embodiment of the present invention;

FIG. 2 depicts an exemplary manpower requirement by skill;

FIG. 3 depicts an exemplary dynamic allocation;

FIG. 4 depicts an exemplary block diagram of dynamic allocation;

FIG. 5 depicts an exemplary dump and fill target for forecasting;

FIG. 6 depicts an exemplary dynamic allocation;

FIG. 7 depicts an exemplary dynamic allocation;

FIG. 8 depicts a block diagram of an uptime schedule adjustment;

FIG. 9 depicts a block diagram of a downtime schedule adjustment;

FIG. 10 depicts an exemplary recurring schedule, uptime adjustment and downtime adjustment;

FIG. 11 depicts an exemplary modified work schedule;

FIG. 12 depicts a block diagram of maintaining a work schedule;

FIG. 13 depicts an exemplary event based forecast;

FIG. 14 depicts a first method of dynamically allocating a work schedule in accordance with a preferred embodiment of the present invention;

FIG. 15 depicts a second method of dynamically allocating a work schedule in accordance with a preferred embodiment of the present invention;

FIG. 16 depicts a first software flow block of dynamically allocating a work schedule in accordance with a preferred embodiment of the present invention;

FIG. 17 depicts a second software flow block of dynamically allocating a work schedule in accordance with a preferred embodiment of the present invention;

FIG. 18 depicts a first system for dynamically allocating a work schedule in accordance with a preferred embodiment of the present invention; and

FIG. 19 depicts a second system for dynamically allocating a work schedule in accordance with a preferred embodiment of the present invention.

### DETAILED DESCRIPTION OF THE INVENTION

The present invention provides improved systems and methods for staffing, scheduling, and managing a plurality of employees. In one embodiment, the system includes at least one computer configured with software to receive work force requirement data and create schedules based on the work force requirement data using any of many various scheduling algorithms. Hence, based on input regarding previous work force requirements or anticipated work force requirements, the scheduling system creates work force requirements and offers uptime and downtime adjustments to satisfy those requirements.

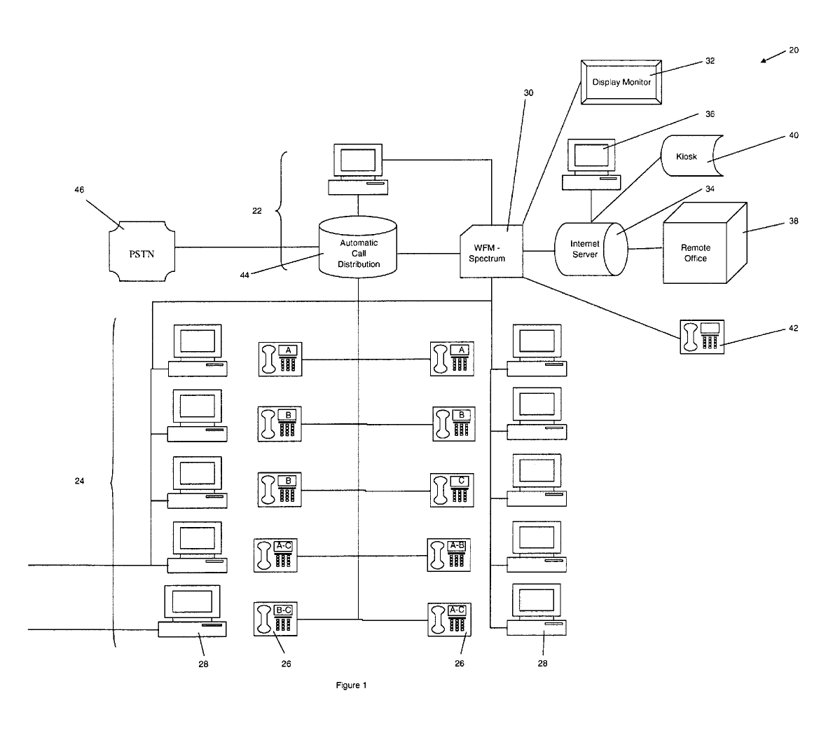

Although other applications are possible, one example environment 20 in which the subject invention can be implemented is shown in FIG. 1. As shown, one example environment comprises a large office building or office complex having management offices 22 and employee work area 24. In this example environment the employee work area comprises the floor of a telephone services operation 26, such as for receiving or placing telephone sales calls. The work area includes rows of stations, each station having a terminal 28.

For purposes of the present application, the term management is used in reference to a person of authority over workers or employees. In general, management or managers have a different level of authorization in the scheduling system than workers or employees, thereby providing managers access to features of the scheduling system that are inaccessible to workers or employees. In contrast, the terms worker and employee, used interchangeably, refer to the individuals for whom schedules are created, maintained, and monitored. The difference between these terms will become apparent after reading the detailed description that follows.

Within the management office is a computer server 30 configured to execute software written to achieve the function of the present invention. The server 30 and software running thereon receive input from management including but not limited to employee files, workload data, and schedule changes. The server 30 communicates employee schedule data to one or more monitors 32 for display to employees. In one configuration, the monitors are large overhead-mounted video display monitors able to simultaneously visually communicate the schedule data to a plurality of individuals.

In the example environment shown in FIG. 1, one or more computer workstations or kiosks 28 reside throughout the employee work area. Each kiosk provides means for the employees to access and/or print their work schedules. For example, the kiosk may be accessed by the cellular phone or the computer with external wireless capability (such as the wireless card) or internal wireless capability (such as 802.11 or any of the other 802 variants), or by the Internet Protocol enabled phone. The communications occurs via at least one of the wireless protocol, the wired protocol and the combination of the wireless protocol and the wired protocol.

Included in this example environment is an Internet server 34 that connects to the Internet or other computer network. The Internet server facilitates connection to the scheduling system by one or more individuals or entities at one or more remote locations 36. For example, in this environment, employees located at their homes may connect to the scheduling system over the Internet to ascertain their work schedule or utilize other functions of the scheduling system of the present invention. The transfer of information between the agent and the present invention WFM system occurs via at least one of a wireless protocol, a wired protocol and the combination of the wireless protocol and the wired protocol. The steps performed in this figure are performed by software, hardware, firmware, and/or the combination of software, hardware, and/or firmware.

For example, in this environment, employees located at their homes may connect to the scheduling system over the Internet to ascertain their work schedule or utilize other functions of the scheduling system of the present invention.

In the example environment shown here, the present invention also facilitates a connection to one or more remote offices 38. In the example environment shown, the remote office comprises another telephone services call center located in another city. The transfer of information occurs via at least one of a wireless protocol, a wired protocol and the combination of the wireless protocol and the wired protocol. The steps performed in this figure are performed by software, hardware, firmware, and/or the combination of software, hardware, and/or firmware.

As shown, the scheduling system interfaces with a central mainframe computer such as a main computer that acts as the center of a companys computer network. In one configuration, the main computer 30 comprises an IBM® brand, Tandem® brand, or other similar mainframe computer operating under a UNIX®, Linux™, or Windows™ family, or other operating system. The particular configuration or apparatus of the main computer 30 is not significant to the present invention other than that it is preferably capable of the functions described herein. The main computer 30 interfaces with the scheduling system, coordinates the receiveance of calls into the call processing system, and communicates schedule data to the employee scheduling system components. For example, in this embodiment the employee scheduling system of the present invention utilizes the data storage, printing, and display facilities of main computer 30.

Within this example environment of a telephone services call center, the system allows for access to the data via a number of access points, including but not limited to a workers computer terminal, centrally located user-interactive kiosks 40, large display monitors 32, telephone 42, Internet, or electronic mail. The transfer of information between the kiosk and the customer premises occurs via at least one of a wireless protocol, a wired protocol and the combination of the wireless protocol and the wired protocol. The steps performed in this figure are performed by software, hardware, firmware, and/or the combination of software, hardware, and/or firmware.

As the present invention is discussed herein in the environment of a call processing system, an automatic call distributor 44 connects intermediate the main computer 30 and the Public Switched Telephone Network (PSTN) 46. The automatic call distributor 44 receives calls, such as calls from customers requesting to purchase an advertised product, via the PSTN 46. Upon receipt of a call, the automatic call distributor 44 may direct the call through the main computer to a call processing system. The call processing apparatus provides means for an employee to service the call, such as by taking the telephone order.

In this illustrative embodiment, the present invention works in conjunction with the main computer, automatic call distributor, and call processing system. The present invention, while operating in conjunction with these systems, is generally independent from the call processing apparatus and automatic call distributor, and is described in this example environment only for purposes of understanding.

The present invention thus comprises an employee scheduling apparatus configured to execute software configured to achieve the functionality of the present invention. The software is described below in greater detail. In one embodiment, the employee scheduling apparatus comprises a computer capable of interfacing with the main frame and executing software. One such computer can be based on a Pentium™ or other suitable processor running a Windows™ family, UNIX™, Linux™, or other operating system. It is contemplated that the employee scheduling apparatus includes at least one data entry device and at least one display device.

The employee scheduling apparatus utilizes the main computer to access one or more database storage devices, such as, by way of example and not limitation, hard disk drives, read/write optical storage, tape drives, and the like. As described below in greater detail, one configuration of the software utilizes the storage device to store employee data, schedule data, and call statistic data.

Although the present invention is described above in an example embodiment of a telephone service call center, it is anticipated that the present invention may be utilized by any of a number of different environments where it is desirable to manage two or more employees.

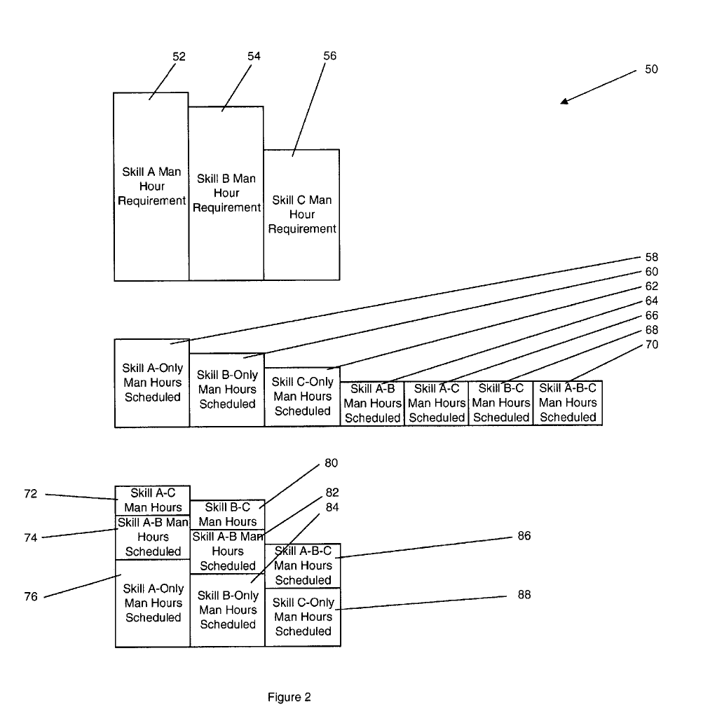

FIG. 2 illustrates how the present invention schedules 50 man hour skills to meet man hour skill requirements. Man hour requirements are forecasted, such as skill A 52, skill B 54 and skill C 56, based on well established principles utilizing past information, weighted averages and linear regression. The present invention utilizes in a more comprehensive way the information available as to skill assessment, whether it is single skill only 58, 60, 62, or multiple skill 64, 66, 68, 70. In the present example the single skilled individuals are placed in those skill requirement positions 76, 84, 88, and the multiple skilled individuals 72, 74, 80, 82, and 86 are scheduled such that the skill man hour requirements are most evenly met by reallocating multiple skilled individuals to where they are needed. The use of this multiple skill information allows much more flexibility of workforce reallocation to meet customer needs.

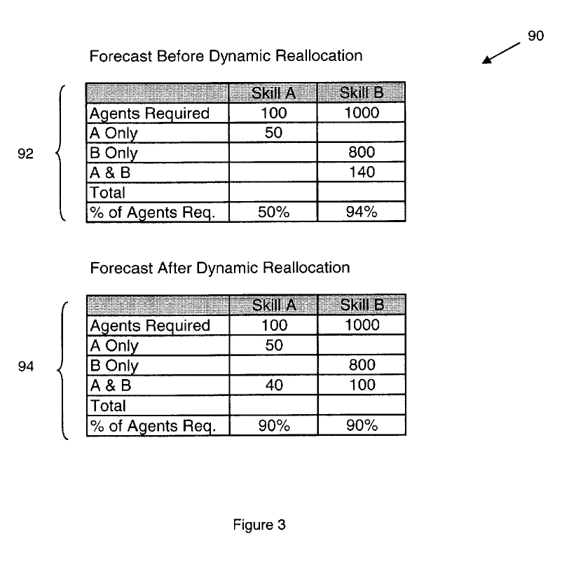

FIG. 3 illustrates an example of how the present invention 90 schedules man hour skills to meet man hour skill requirements. For example, Let us assume that there are two Skills, Skill A & Skill B. For a given interval the forecast indicates that 100 agents are required to work Skill A, and 1000 agents are required to work skill B. Let us assume we have only 50 agents who are dedicated to work skill A only, and we have 800 agents who are available to work skill B. We have 140 agents who are scheduled to work the skill combo of A & B. If the agents possessing both skill A and skill B are placed in the skill B need, the percentage of agents in A would be 50% and in B would be 94%, 92. The present invention would allocate 40 of these agents to Skill A and 100 of these agents to Skill B which results in both skills having 90% of the required number of agents, 94. The allocation process does not result in any actual change to any agents schedule, nor are individual agents allocated. The purpose of allocation is simply to determine the difference between the number of agents currently scheduled and the number of agents required. Allocation is not static. Anytime a forecast is modified or an agents schedule is modified the allocation may become sub-optimal. The present invention will dynamically reallocate agents as changes are made to either schedules or forecasts. The frequency of the reallocation varies upon a number of factors, but reallocation for a given interval will normally occur several times an hour.

The system allows the user to define the combination of skills that may be worked concurrently by a user as a skill combo. Not all skills may be worked concurrently, for many reasons. The users may only be assigned to work valid skill combos that are based upon the actual routing rules for the calls delivered via the ACD. A single skill may be used in any number of Skill Combos. MS Agents are scheduled to skill combos. When scheduled to multiple skills the system assumes no preference or priority. It is understood that the agent may be taking calls for any of the skills in the Skill Combo during the interval scheduled. When determining how many agents who are currently scheduled will be available to work a skill, the present invention will allocate the counts multi-skilled agents to one or more of the skills in the skill combo, based upon the percentage of the total number of agents required for each skill.

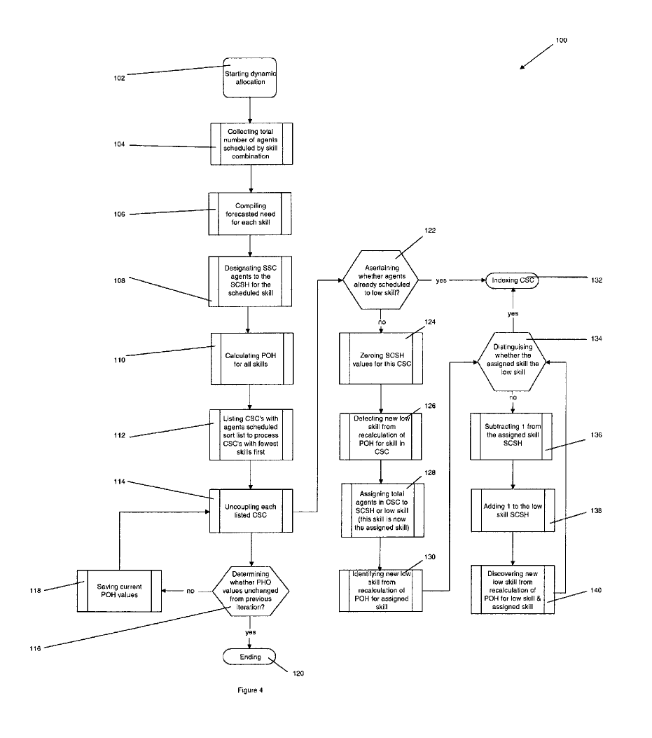

Referring now to FIG. 4, a first software flow diagram 100 of dynamic reallocation is depicted. The computer readable medium comprises collecting 104 the total number of agent scheduled by skill combination, aggregating 106 the forecasted need for each skill, allocating 108 all Simple Skill Combination (SSC) agents to the skill combination skill have list for the scheduled skill, determining 110 the Percentage Of Have (POH) for each skill, saving 116 the current POH values, building 112 a skill list for all of the Complex Skill Combinations (CSC) agents scheduled, sorting the list to process the complex skill combination agents with the fewest skills first, uncoupling 114 each complex skill combination in the skill list ascertaining 122 whether all complex skill combination agents are already scheduled to the low percentage of have skill. If all complex skill combination agents are not scheduled to the low skill, zeroing 124 the Skill Combination Skill Have (SCSH) for this complex skill combination, detecting 126 the percentage of have for the skill, this skill is now the assigned skill, and determine new low skill, assigning 128 total agents in complex skill combination to skill combination skill have or the low skill and identifying 130 the percentage of have to determine new low skill. Indexing 132 the skill, querying 134 whether the assigned skill is the low skill, subtracting one 136 from the assigned skill combination skill have and adding one 138 to the low skill, redetermining 140 the percentage of have for the low skill and the assigned skill and determine the low skill. Determining 116 if the POH has not changed from the previous iteration which indicates that optimization has been achieved.

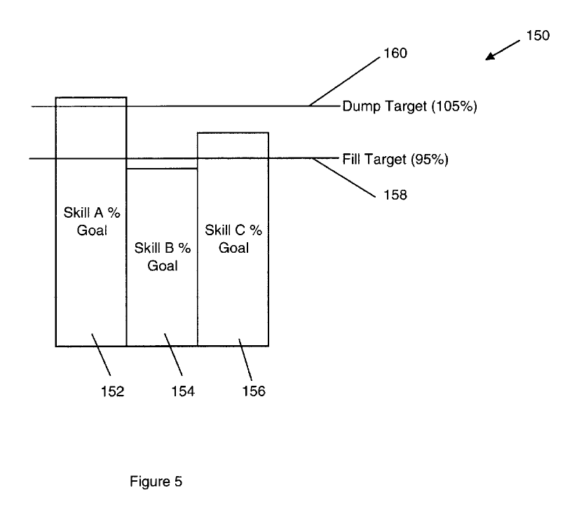

Referring now to FIG. 5, an overview of dump and fill target for a skill 150 is shown. The present invention WFM system departs from traditional WFM because it does not attempt to dictate schedules to employees. Each employee is given a recurring schedule that repeats each week, similar to how most people in the workforce are scheduled. The system allows the creation of automatic sheets which allow the user to establish goals for each skill, 152, 154, 156 for a set of intervals, usually a week. The user may set both a fill target 158 and a dump target 160 as a percentage of the total number of agents required. A sheet is a manager-created option or sign-up list requesting that employees make voluntary schedule changes based on future anticipated workload. Once created, a sheet is posted in this example electronically, by management, thereby allowing workers to sign-up for the specified schedule changes. For example, if management determines that additional workers are required, often because the workload level has changed, then management or any authorized user may create a sheet. In one example configuration, the sheet includes information regarding the shift that the sheet is directed to, whether additional workers or fewer workers are needed, how many more or fewer workers are required, and text entry areas for workers to sign-up for the sheet. Thus, a sheet may be used to add to the number of workers scheduled for a shift or to reduce the number of workers scheduled for a shift.

The upper threshold may correspond to a dump percentage, at which the shift is considered overstaffed and the sheets sub-module will post sheets to lower or decrease the number of employees assigned to the given shift. The lower threshold may correspond to a fill percentage, at which the shift is considered under-staffed, and the sheets would post sheets to increase the number of employees assigned to the shift. In this second scenario, the sheets sub-module could post sheets until the percentage of slots filled for the given shift falls between the fill percentage and the dump percentage, thus affording more flexibility than the first scenario described above. The target point between the upper and lower thresholds may be specified precisely, or may be specified using known fuzzy logic techniques.

As long as the number of agents allocated to work the skill is less than the fill percentage target the system will offer Uptime adjustments to qualified agents. As long as the number of agents allocated to work the skill is greater than the dump percentage target the system will offer Downtime adjustments to qualified agents. For example, the user may create an Automatic Sheet for Skill A for a given week. The fill target is set to 95% and the dump target is set to 105%. If the number of agents required to work one of the intervals is 1000 then the present invention will offer uptime as long as the number of agents allocated to Skill A is below 950 and will offer downtime as long as the number of agents allocated to Skill A is above 1050. The dump and fill targets are both based upon the forecasted number of agents required, but they operate independently. In the example above there is a gap between 95% and 105% where the present invention would offer neither uptime nor downtime adjustments; however the targets could be reversed so that uptime would be offered while we are below 105% and downtime could be offered while we are above 95%. In this case when the number of scheduled agents is between 95% and 105% the present invention would offer both uptime adjustments and downtime adjustments. Any agent who wishes to do so may access the system via the web or a kiosk and modify their schedule.

Agents who wish to work extra hours will have displayed to them any uptime adjustments that they are eligible to receive. If the agent receives the adjustment, the system will automatically modify their schedule to work the intervals received. Agents who wish to work fewer hours will have displayed to them any downtime adjustments that they are eligible to receive for intervals to which they are currently scheduled. If the agent receives the adjustment, the system will automatically modify their schedule to no longer work the intervals received. MS Agents may be offered uptime adjustments that are multi-skilled. The system automatically converts the offer generated by an Automatic Sheet for a skill into an uptime adjustment for a Skill Combo based upon the skills that the agent is qualified to work. If any skill in a Skill Combo is offering uptime, the uptime adjustment will be offered; however, downtime is only offered if all of the skills in the Skill Combo are currently offering downtime.

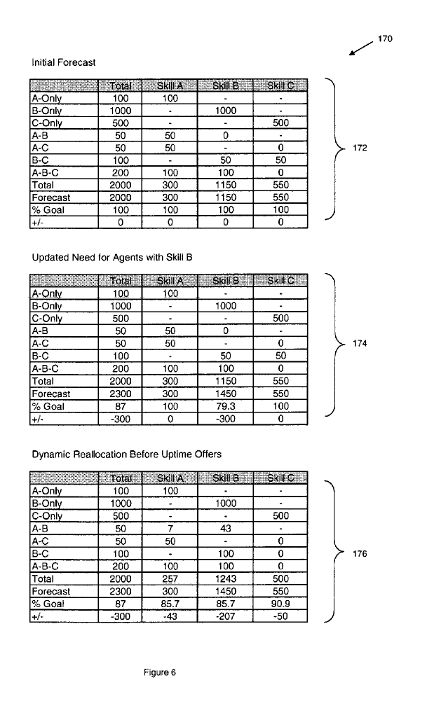

Referring now to FIG. 6, an overview of dynamic allocation and automatic sheets 170 is shown. One of the features of the invention is the way that Dynamic Allocation works in conjunction with Automatic Sheets. In the initial forecast 172 we have three skills, A, B & C. We have agents scheduled to 7 different Skill Combos, including three dedicated combos (one skill only) and four that have more than one skill. The total number of agents scheduled is 2000, and the total number of agents required by the forecast is 2000. Through allocation, every skill is currently scheduled to exactly 100% of the goal, and the number of agents over or under the forecast (the +/−) for each skill is zero. If a user were to modify the forecast for Skill B due to additional information the situation would look like 174. The forecast for Skill B was modified from 1150 to 1450. This drops skill B to 79.3 percent of the forecast goal. Our delta to the forecast is now −300. However, the present invention would automatically reallocate based upon the change to the forecast and after reallocation the dynamic allocation would have shifted agents as shown in 176 so as to keep offering uptime for skill A. The reallocation results in all of the B-C agents being reallocated from C to B, and some of the A-B agents being reallocated from A to B. A now has a delta of −43 and B has a delta of −207, however notice that both are at 85.7% of the forecasted goal. Skill C is higher, at 90.9% of the forecasted goal, but notice that we do not have anyone else that can be moved from C, since all 500 remaining agents are dedicated C-Only agents. We are now offering uptime for all three skills.

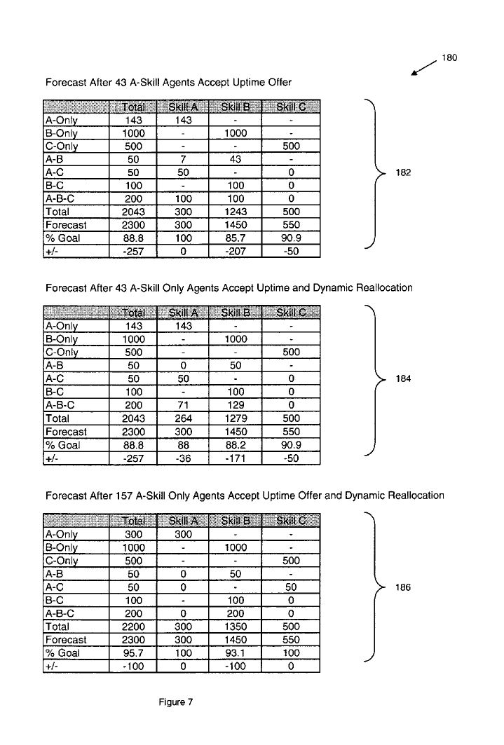

Referring now to FIG. 7, an overview of dynamic allocation and automatic sheets 180 is shown. Lets assume that 43 A-Only agents receive uptime so that A is now back at 100% as shown in 182. If the system were static, we would now be at 100% for A and would stop offering uptime for agents who work that skill. But we never reach this point since all the while we are signing up the 43 new single skilled agents the system is reallocating the multi-skilled agents. After the 43 agents have signed up we actually look like FIG. 184. Assume that we continue to get only agents that can work skill A to sign-up for our uptime shift adjustments. Eventually we would get to 186. At this point we no longer offer uptime for Skill A, since we are at 100% of forecast, and we have no more multi-skilled agents to move. Coincidentally, we happened to get back to 100% for Skill C as well, since all of the multi-skilled A-C agents were moved away from Skill A to Skill C. We are now only offering uptime for Skill B. What this example demonstrated was that when we increased the forecast for skill B by 300, we were able to get an additional 200 agents, even though none of the new agents could work Skill B. This was a particularly unfriendly example since all of the additional agents were single skilled, working the same skill. With a more random distribution of new agents we would be able to receive agents working any of the three skills right up to the last agent. Also worth noting in this example was that after the change to the forecast, all of the actions of the system were automatic. The reallocation happened automatically. The uptime offers were generated automatically as well. No intervention by the staff was required to start increasing the work force beyond changing the forecast.

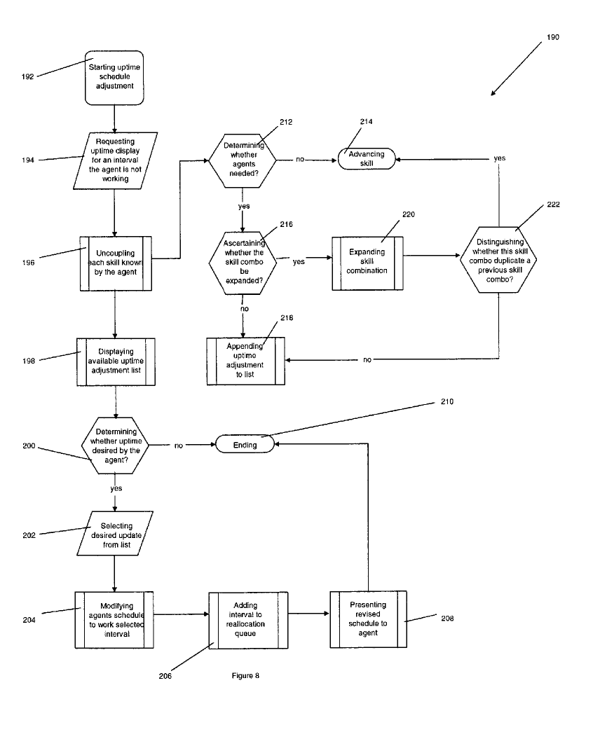

Referring now to FIG. 8, a first software flow diagram 190 of agent uptime schedule adjustment is depicted. The computer readable medium comprises requesting 194 uptime display for and agent who is not working, querying 196 for each skill known by the agent, displaying 198 the available uptime adjustment list, querying 200 whether the uptime is desired by the agent, selecting 202 the desired update from the list, modifying 204 the agents schedule to work the selected interval, adding 206 the interval to the reallocation queue and displaying 208 the revised schedule to the agent, at which point the update has ended 210. The computer readable medium also queries 196 for each skill known by the agent, querying 212 if more agents are needed, querying 216 can the skill combination be expanded if yes and advancing 214 to the next skill if no, adding 218 uptime adjustment to the list if no and expanding 220 the skill combination if yes, querying 222 does the skill duplicate a previous skill combination.

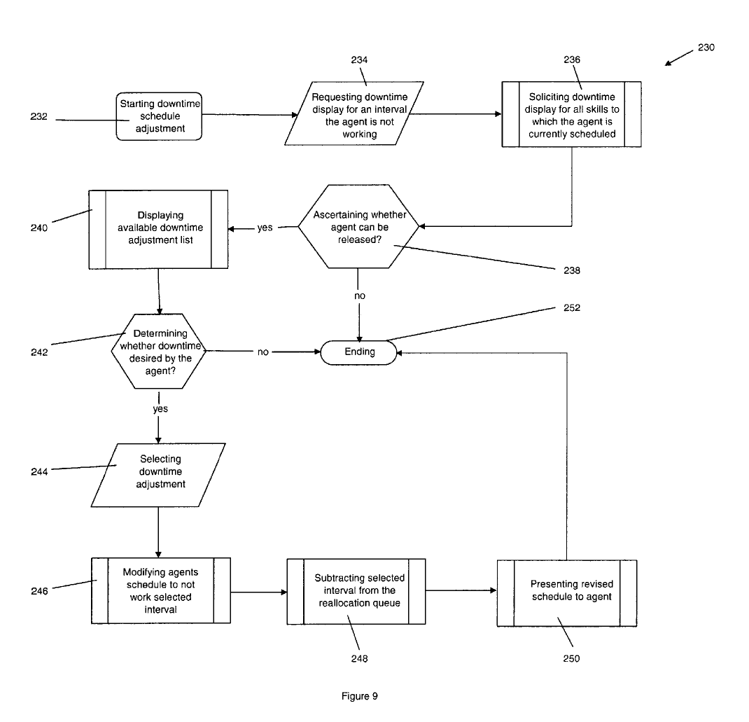

Referring now to FIG. 9, a first software flow diagram 230 of agent downtime schedule adjustment is depicted. The computer readable medium comprises requesting 234 downtime display for an interval the agent is not working, requesting 236 downtime display for all skills for which the agent is currently scheduled, querying 238 whether the agent can be released, if no end, if yes then displaying 240 available downtime adjustment list, querying 242 if downtime is desired by the agent, if no end, if yes, selecting 244 downtime adjustment, modifying 246 the agents schedule to not work the selected interval, subtracting 248 the interval from the reallocation queue, displaying 250 the revised schedule to the agent and ending 252.

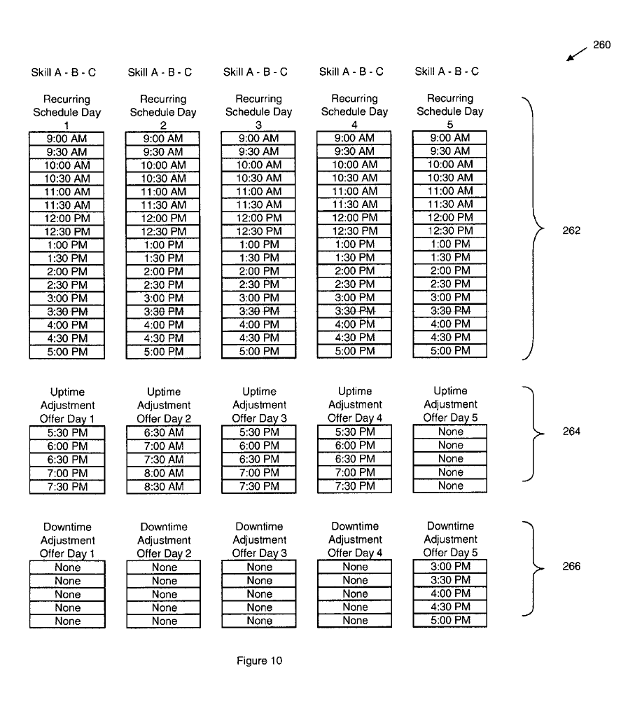

Referring now to FIG. 10, showing a recurring schedule, uptime adjustment offers and downtime adjustment offers of agent 260. The recurring schedule is shown as 262 and is the required schedule, the uptime adjustment offer 264 and the downtime adjustment offer 266 are shown for that week.

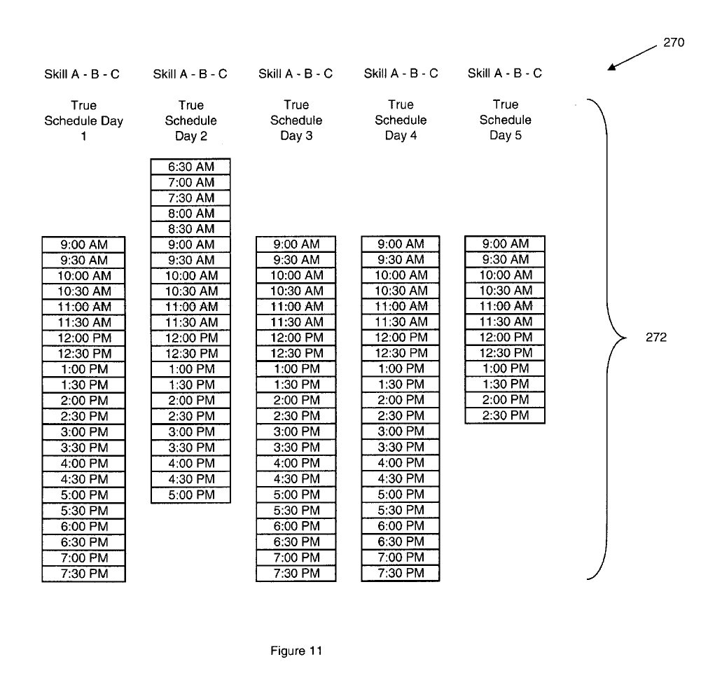

Referring now to FIG. 11, shows the true schedule 270 after adjustments. The updated schedule 272 is shown for that week.

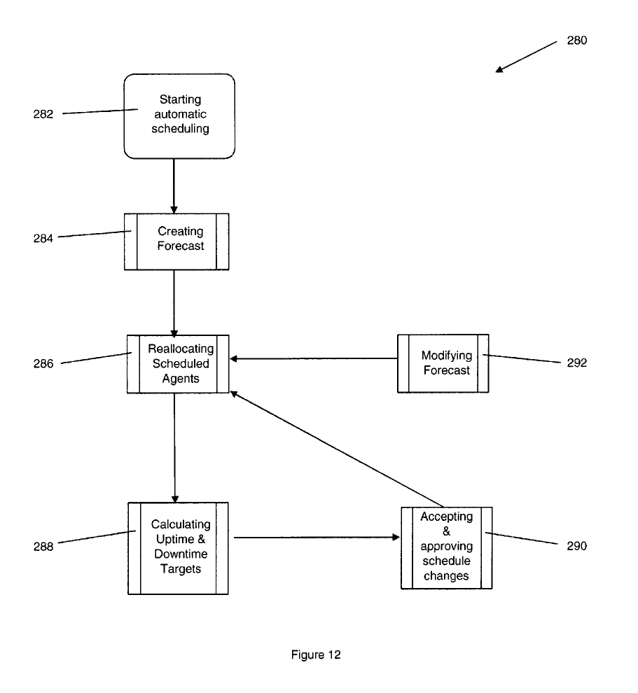

Referring now to FIG. 12, shows automated scheduling 280 in accordance with the preferred embodiment of the invention. The computer readable medium comprises starting 282, creating a forecast 284, reallocating 286 scheduled agents, determining 288 uptime and downtime targets, receiving and approving 290 schedule changes and modifying 292 the forecast.

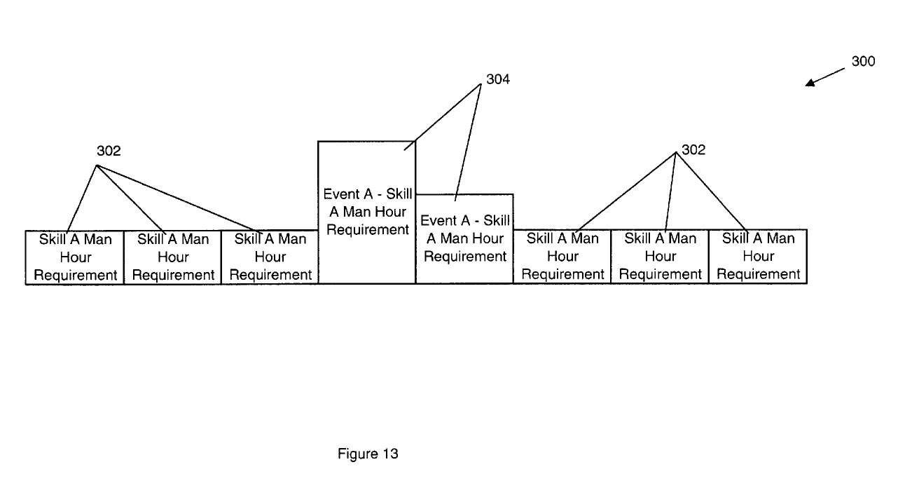

Referring now to FIG. 13, shows event forecasting 300 in accordance with the preferred embodiment of the invention. The illustration shows non-event manpower forecasts 302 and event based forecasts 304. The present invention allows the capturing of events for the purpose of refining forecasts. Events are predictable and repeatable activities that change call volumes that do not occur in a normal day-of-week and time-of-day pattern. Commercials and infomercials would be examples of an event. Events can result in spikes in call volumes that typically last from 30 minutes to an hour, and never longer than three hours. Ignoring the effect of events degrade forecasting accuracy in two ways. First, forecasting volume base on past experience will not anticipate the spike and may result in understaffing. Second, the spike caused by the event will skew the historical data and may result in overstaffing. The historical data will be less accurate and, to the extent we base our forecast on the historical data, the forecast will be degraded by the effect of past events. The present invention includes a tracking system to store the effects of events. This history is then used to adjust historical call volumes for the effect of the event. This results in more accurate analysis of the underlying call volume trends and more forecasts. The present invention also allows future events that are scheduled to be incorporated into the forecast. This permits more accurate forecasts since the impact to call volumes caused by the event can be anticipated.

Reallocation occurs periodically based upon either forecasted changes or schedule changes. The frequency of the allocation for an interval will be determined and will depend on the system resources that are available for the task. The determination of uptime and downtime can be done at the time each agent requests available time. Reallocation can be performed on each request, but for efficiency the determination is done in advance. Schedule changes will be occurring constantly as agents modify their schedules by receiving uptime and downtime, and also due to other changes, which can be triggered by a schedule change. Forecasts will change less frequently than schedules, but may have a dramatic impact on the targets. When they occur, they will trigger a reallocation. The system will continue to evaluate the number of agents against the goal for future intervals.

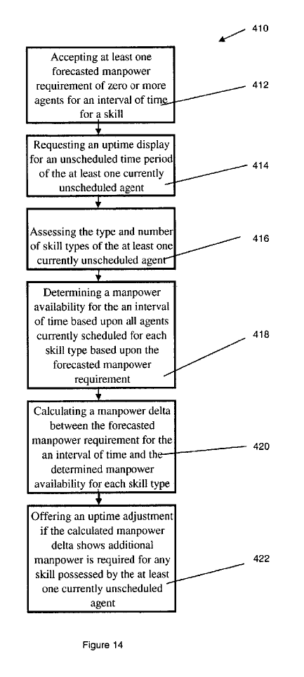

Referring now to FIG. 14, shows a first method for offering uptime adjustments to a work schedule 410 in accordance with the preferred embodiment of the invention. A method for offering uptime adjustments to a work schedule for at least one currently unscheduled agent possessing at least one skill type, that comprises, accepting 412 at least one forecasted manpower requirement of zero or more agents for an interval of time for a skill, requesting 414 an uptime display for an unscheduled time period of the at least one currently unscheduled agent, assessing 416 the type and number of skill types of the at least one currently unscheduled agent, determining 418 a manpower availability for the an interval of time based upon all agents currently scheduled for each skill type based upon the forecasted manpower requirement, calculating 420 a manpower delta between the forecasted manpower requirement for the an interval of time and the determined manpower availability for each skill type, and offering 422 an uptime adjustment if the calculated manpower delta shows additional manpower is required for any skill possessed by the at least one currently unscheduled agent. The method is performed by software, hardware, firmware, and/or the combination of software, hardware, and/or firmware.

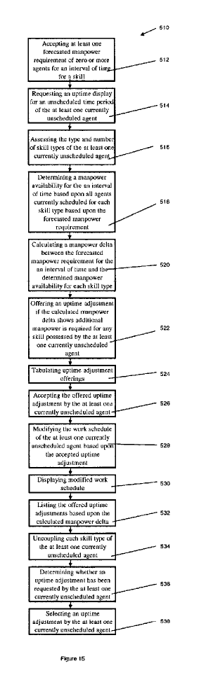

Referring now to FIG. 15, shows a second method for offering uptime adjustments to a work schedule 510 in accordance with the preferred embodiment of the invention. A method for offering uptime adjustments to a work schedule for at least one currently unscheduled agent possessing at least one skill type, that comprises, accepting 512 at least one forecasted manpower requirement of zero or more agents for an interval of time for a skill, requesting 514 an uptime display for an unscheduled time period of the at least one currently unscheduled agent, assessing 516 the type and number of skill types of the at least one currently unscheduled agent, determining 518 a manpower availability for the an interval of time based upon all agents currently scheduled for each skill type based upon the forecasted manpower requirement, calculating 520 a manpower delta between the forecasted manpower requirement for the an interval of time and the determined manpower availability for each skill type, and offering 522 an uptime adjustment if the calculated manpower delta shows additional manpower is required for any skill possessed by the at least one currently unscheduled agent. The method may additionally comprise tabulating 524 uptime adjustment offerings, accepting 526 the offered uptime adjustment by the at least one currently unscheduled agent, modifying 528 the work schedule of the at least one currently unscheduled agent based upon the accepted uptime adjustment, displaying 530 modified work schedule and listing 532 the offered uptime adjustments based upon the calculated manpower delta. The method may further comprise uncoupling 534 each skill type of the at least one currently unscheduled agent, determining 536 whether an uptime adjustment has been requested by the at least one currently unscheduled agent and selecting 538 an uptime adjustment by the at least one currently unscheduled agent. Wherein the interval of time is one scheduled work shift, the assessment has a priority which is based upon the calculated manpower delta and the forecasted manpower requirement is periodically updated. The method is performed by software, hardware, firmware, and/or the combination of software, hardware, and/or firmware.

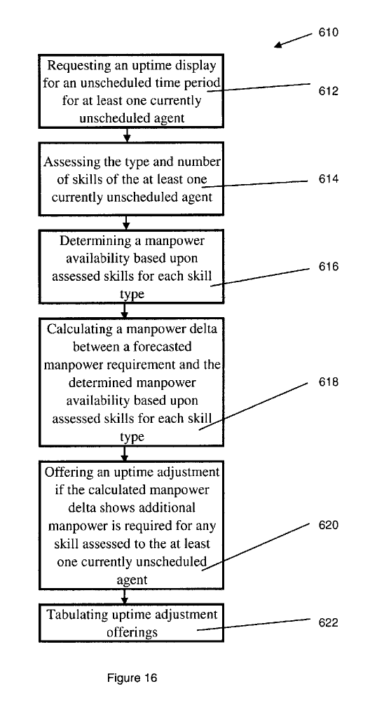

Referring now to FIG. 16, shows a first software flow block for offering uptime adjustments to a work schedule 610 accordance with the preferred embodiment of the invention. A computer readable medium that comprises instructions that comprises, requesting 612 an uptime display for an unscheduled time period for at least one currently unscheduled agent, assessing 614 the type and number of skills of the at least one currently unscheduled agent, determining 616 a manpower availability based upon assessed skills for each skill type, calculating 618 a manpower delta between a forecasted manpower requirement and the determined manpower availability based upon assessed skills for each skill type, offering 620 an uptime adjustment if the calculated manpower delta shows additional manpower is required for any skill assessed to the at least one currently unscheduled agent, and tabulating 622 uptime adjustment offerings. The transfer of information between the processor and the memory occurs via at least one of a wireless protocol, a wired protocol and the combination of a wireless protocol and a wired protocol. These steps are performed by software but in other embodiments, may be performed by hardware, firmware, and/or the combination of software, hardware, and/or firmware without departing from the scope of the present invention.

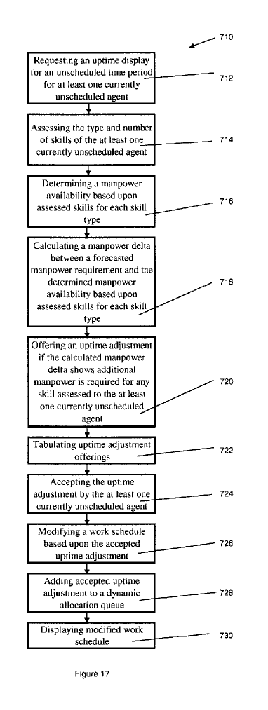

Referring now to FIG. 17, shows a second software flow block for offering uptime adjustments to a work schedule 710 accordance with the preferred embodiment of the invention. A computer readable medium that comprises instructions that comprises, requesting 712 an uptime display for an unscheduled time period for at least one currently unscheduled agent, assessing 714 the type and number of skills of the at least one currently unscheduled agent, determining 716 a manpower availability based upon assessed skills for each skill type, calculating 718 a manpower delta between a forecasted manpower requirement and the determined manpower availability based upon assessed skills for each skill type, offering 720 an uptime adjustment if the calculated manpower delta shows additional manpower is required for any skill assessed to the at least one currently unscheduled agent, and tabulating 722 uptime adjustment offerings. The computer readable medium may additionally comprise instructions for accepting 724 the uptime adjustment by the at least one currently unscheduled agent, modifying 726 a work schedule based upon the accepted uptime adjustment, adding 728 accepted uptime adjustment to a dynamic allocation queue and displaying 730 modified work schedule. The transfer of information between the processor and the memory occurs via at least one of a wireless protocol, a wired protocol and the combination of a wireless protocol and a wired protocol. These steps are performed by software but in other embodiments, may be performed by hardware, firmware, and/or the combination of software, hardware, and/or firmware without departing from the scope of the present invention.

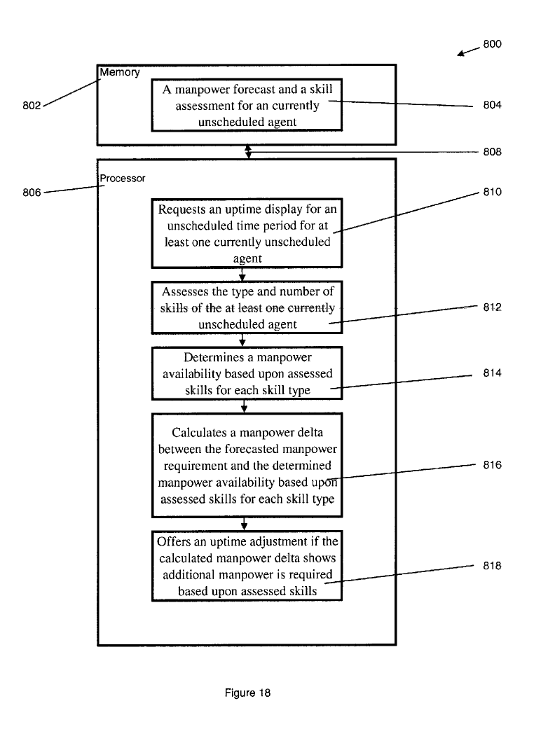

Referring now to FIG. 18, shows a first system for offering uptime adjustments to a work schedule 800 in accordance with the preferred embodiment of the invention. A system for offering uptime adjustments to a work schedule wherein a manpower requirement is forecasted for at least one currently unscheduled agent possessing at least one skill type, that comprises, a memory 802 that receives 804 at least one of, a manpower forecast and a skill assessment for an currently unscheduled agent, and a processor 806 communicably coupled 808 to the memory, wherein the processor, requests 810 an uptime display for an unscheduled time period for at least one currently unscheduled agent, assesses 812 the type and number of skills of the at least one currently unscheduled agent, determines 814 a manpower availability based upon assessed skills for each skill type, calculates 816 a manpower delta between the forecasted manpower requirement and the determined manpower availability based upon assessed skills for each skill type, and offers 818 an uptime adjustment if the calculated manpower delta shows additional manpower is required based upon assessed skills. The transfer of information between the processor and the memory occurs via at least one of a wireless protocol, a wired protocol and a combination of a wireless protocol and a wired protocol. The steps performed in this figure are performed by software, hardware, firmware, and/or the combination of software, hardware, and/or firmware.

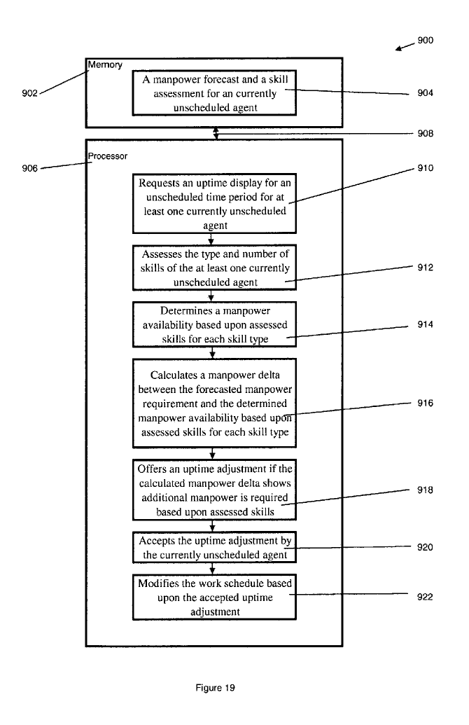

Referring now to FIG. 19, shows a second system for offering uptime adjustments to a work schedule 900 accordance with the preferred embodiment of the invention. A system for offering uptime adjustments to a work schedule wherein a manpower requirement is forecasted for at least one currently unscheduled agent possessing at least one skill type, that comprises, a memory 902 that receives 904 at least one of, a manpower forecast and a skill assessment for an currently unscheduled agent, and a processor 906 communicably coupled 908 to the memory, wherein the processor, requests 910 an uptime display for an unscheduled time period for at least one currently unscheduled agent, assesses 912 the type and number of skills of the at least one currently unscheduled agent, determines 914 a manpower availability based upon assessed skills for each skill type, calculates 916 a manpower delta between the forecasted manpower requirement and the determined manpower availability based upon assessed skills for each skill type, and offers 918 an uptime adjustment if the calculated manpower delta shows additional manpower is required based upon assessed skills. The system processor may additionally accept 920 the uptime adjustment by the currently unscheduled agent and modify 922 the work schedule based upon the accepted uptime adjustment. The transfer of information between the processor and the memory occurs via at least one of a wireless protocol, a wired protocol and a combination of a wireless protocol and a wired protocol. The steps performed in this figure are performed by software, hardware, firmware, and/or the combination of software, hardware, and/or firmware.

In short, this embodiment of the invention may reside either on a medium directly addressable by the computers processor (main memory, however implemented) or on a medium indirectly accessible to the processor (secondary storage media such as hard disk drives, tape drives, CD-ROM drives, floppy drives, or the like). Consistent with the above teaching, the program storage device can be affixed either permanently or removably to a bay, socket, connector, or other hardware provided by the cabinet, motherboard, or other component of a given computer system.

Those skilled in the art, when reading this description, will understand that unless expressly stated to the contrary, the use of the singular or the plural number herein is illustrative, rather than limiting, of the instant invention. Accordingly, where a given term is discussed in the singular number, it will be well understood that the invention also contemplates a plural number of the item corresponding to the given term and vice versa, unless expressly stated herein to the contrary.

Those skilled in the art will further recognize that for the purposes of convenience, legibility, and clarity, various data stores or databases are illustrated herein as separate entities, and are discussed separately. However, as to these data stores in particular, the embodiments shown herein are illustrative rather than limiting, and that some or all of these various data stores could readily be combined or consolidated into one or more data stores or databases without departing from the scope of the invention.

The term data store herein refers to any storage medium capable of storing data, whether realized using semiconductor, magnetic, or optical technology. This term can also include abstract data structures supported by any number of programming languages, with non-limiting examples including queues, stacks, linked lists or the like, all of which are implemented at the machine level by disk storage, semiconductor memory, optical media, or the like. If a given data store is implemented as a database, this database can take the form of a relational database, an object-oriented database, and any combination thereof, or any other known database technology. Suitable database server programs are readily available from a variety of vendors, including IBM/Informix, Microsoft, Oracle, or the like.

Various embodiments of the invention are described above to facilitate a thorough understanding of various aspects of the invention. However, these embodiments are to be understood as illustrative rather than limiting in nature, and those skilled in the art will recognize that various modifications or extensions of these embodiments will fall within the scope of the invention, which is defined by the appended claims. While particular embodiments and examples of the present invention have been described above, it should be understood that they have been presented by way of example only and not as limitations. Those of ordinary skill in the art will readily appreciate that other various embodiments or configurations adopting the principles of the subject invention are possible. The breadth and scope of the present invention is defined by the following claims and their equivalents, and is not limited by the particular embodiments described herein.

Although an exemplary embodiment of the system of the present invention has been illustrated in the accompanied drawings and described in the foregoing detailed description, it will be understood that the invention is not limited to the embodiments disclosed, but is capable of numerous rearrangements, modifications, and substitutions without departing from the spirit of the invention as set forth and defined by the following claims. For example, the capabilities of the invention can be performed fully and/or partially by one or more of the KIOSKs, loop interface remote terminal ends, access management system or internet protocol devices. Also, these capabilities may be performed in the current manner or in a distributed manner and on, or via, any device able to provide and/or receive broadband signals. Further, although depicted in a particular manner, various modules or blocks may be repositioned without departing from the scope of the current invention. For example, the functionality performed by the loop interface remote terminal end can be self-contained. Still further, although depicted in a particular manner, a greater or lesser number KIOSKs, DSL transceivers, residential gateways, DC terminations and internet protocol devices can be utilized with the present invention in order to accomplish the present invention, to provide additional known features to the present invention, and/or to make the present invention more efficient.

Although an exemplary embodiment of the system of the present invention has been illustrated in the accompanied drawings and described in the foregoing detailed description, it will be understood that the invention is not limited to the embodiments disclosed, but is capable of numerous rearrangements, modifications, and substitutions without departing from the spirit of the invention as set forth and defined by the following claims. For example, the capabilities of the invention can be performed fully and/or partially by one or more of the processors. Also, these capabilities may be performed in the current manner or in a distributed manner and on, or via, any device able to provide, send and/or receive lookup data. Further, although depicted in a particular manner, various modules or blocks may be repositioned without departing from the scope of the current invention. For example, the functionality performed by the processor and memory can be self-contained. Still further, although depicted and/or described in a particular manner, a greater or lesser number or processors and memories can be utilized with the present invention in order to accomplish the present invention, to provide additional known features to the present invention, and/or to make the present invention more efficient. Also, communication between such modules or blocks can occur via a cellular phone, a computer with external wireless capability (such as a wireless card) or internal wireless capability (such as 802.11 or any of the other 802 variants), an Internet Protocol enabled phone, and/or any device that is able to send and receive information.

What is claimed is:

1. A method for offering uptime adjustments to a work schedule for at least one currently unscheduled agent possessing at least one skill type, comprising:
accepting at least one forecasted manpower requirement of zero or more agents for an interval of time for a skill;
requesting an uptime display for an unscheduled time period of the at least one currently unscheduled agent;
assessing the type and number of skill types of the at least one currently unscheduled agent;
determining a manpower availability for the an interval of time based upon all agents currently scheduled for each skill type based upon the forecasted manpower requirement;
calculating a manpower delta between the forecasted manpower requirement for the an interval of time and the determined manpower availability for each skill type; and
offering an uptime adjustment if the calculated manpower delta shows additional manpower is required for any skill possessed by the at least one currently unscheduled agent.

2. The method of claim 1 comprising:
tabulating uptime adjustment offerings.

3. The method of claim 1 comprising:
accepting the offered uptime adjustment by the at least one currently unscheduled agent.

4. The method of claim 3 comprising:
modifying the work schedule of the at least one currently unscheduled agent based upon the accepted uptime adjustment.

5. The method of claim 4 comprising:
displaying modified work schedule.

6. The method of claim 1 comprising:
listing the offered uptime adjustments based upon the calculated manpower delta.

7. The method of claim 1 comprising:
uncoupling each skill type of the at least one currently unscheduled agent.

8. The method of claim 1 comprising:
determining whether an uptime adjustment has been requested by the at least one currently unscheduled agent.

9. The method of claim 1 comprising:
selecting an uptime adjustment by the at least one currently unscheduled agent.

10. The method of claim 1 wherein the interval of time is one scheduled work shift.

11. The method of claim 1 wherein the assessment has a priority which is based upon the calculated manpower delta.

12. The method of claim 1 wherein the forecasted manpower requirement is periodically updated.

13. A computer readable medium comprising instructions comprising:
requesting an uptime display for an unscheduled time period for at least one currently unscheduled agent;
assessing the type and number of skills of the at least one currently unscheduled agent;
determining a manpower availability based upon assessed skills for each skill type;
calculating a manpower delta between a forecasted manpower requirement and the determined manpower availability based upon assessed skills for each skill type;
offering an uptime adjustment if the calculated manpower delta shows additional manpower is required for any skill assessed to the at least one currently unscheduled agent; and
tabulating uptime adjustment offerings.

14. The computer readable medium of claim 13 comprising instructions for:
accepting the uptime adjustment by the at least one currently unscheduled agent.

15. The computer readable medium of claim 14 comprising instructions for:
modifying a work schedule based upon the accepted uptime adjustment.

16. The computer readable medium of claim 14 comprising instructions for:
adding accepted uptime adjustment to a dynamic allocation queue.

17. The computer readable medium of claim 15 comprising instructions for:
displaying modified work schedule.

18. A system for offering uptime adjustments to a work schedule wherein a manpower requirement is forecasted for at least one currently unscheduled agent possessing at least one skill type, comprising:
a memory that receives at least one of: a manpower forecast and a skill assessment for an currently unscheduled agent; and
a processor communicably coupled to the memory, wherein the processor:
requests an uptime display for an unscheduled time period for at least one currently unscheduled agent;
assesses the type and number of skills of the at least one currently unscheduled agent;
determines a manpower availability based upon assessed skills for each skill type;
calculates a manpower delta between the forecasted manpower requirement and the determined manpower availability based upon assessed skills for each skill type; and
offers an uptime adjustment if the calculated manpower delta shows additional manpower is required based upon assessed skills.

19. The system of claim 18 wherein the processor:
accepts the uptime adjustment by the currently unscheduled agent.

20. The system of claim 19 wherein the processor:
modifies the work schedule based upon the accepted uptime adjustment.
